(19) United States
(12) Patent Application Publication
(10) Pub. No.: US 2026/0312698 A1
(43) Pub. Date: Oct. 8, 2026

(54) DENSE BATTERY-LESS ENERGY HARVESTING TAG (ETAG) DEPLOYMENTS FOR BUILDING AND CALIBRATING RADIO DIGITAL TWINS

(71) Applicant: QUALCOMM Incorporated, San Diego, CA (US)

(72) Inventors: Varun Amar REDDY, San Diego, CA (US); Sony AKKARAKARAN, Poway, CA (US); Amit GOEL, San Diego, CA (US)

(21) Appl. No.: 19/572,800

(22) Filed: Mar. 19, 2026

Related U.S. Application Data
(60) Provisional application No. 63/783,432, filed on Apr. 4, 2025.

(51) Int. Cl. H04B 17/11

(52) U.S. Cl. CPC H04B 17/11

(57) ABSTRACT

In some aspects, methods and apparatuses are disclosed for using dense battery-less energy harvesting tag (eTag) deployments to build and calibrate radio digital twins of indoor environments. In some aspects, a method of wireless positioning performed by a network entity includes receiving, from a receiver device, one or more measurements of an environment, the one or more measurements based on a plurality of beacon signal transmissions associated with one or more eTags in the environment; and calibrating a radio digital twin (RDT) based on the one or more measurements.

### CROSS-REFERENCE TO RELATED APPLICATIONS

The present Application for Patent claims the benefit of U.S. Provisional Application No. 63/783,432, entitled “DENSE BATTERY-LESS ENERGY HARVESTING TAG (ETAG) DEPLOYMENTS FOR BUILDING AND CALIBRATING RADIO DIGITAL TWINS,” filed Apr. 4, 2025, assigned to the assignee hereof, and expressly incorporated herein by reference in its entirety.

### BACKGROUND OF THE DISCLOSURE

### 1. Field of the Disclosure

Aspects of the disclosure relate generally to wireless technologies.

### 2. Description of the Related Art

Electronic shelf labels (ESLs) are used by retailers for displaying product pricing or other product information to consumers. ESLs typically use electronic paper (e-paper) or liquid crystal display (LCD) to display the current information. E-paper (also referred to as e-ink) is widely used for ESLs, as it provides a sharp display and supports full graphic imaging while only needing power during updates and no power to retain an image.

ESLs are increasingly being integrated with existing retail technologies, such as electronic article surveillance, digital signage, and people counters. For example, retailers can upload a floor plan of the sales area into the ESL management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless positioning performed by a network entity includes receiving, from a receiver device, one or more measurements of an environment, the one or more measurements based on a plurality of beacon signal transmissions associated with one or more energy harvesting tags (eTags) in the environment; and calibrating a radio digital twin (RDT) based on the one or more measurements.

In an aspect, a network entity includes one or more memories; one or more transceivers; and one or more processors communicatively coupled to the one or more memories and the one or more transceivers, the one or more processors, either alone or in combination, configured to: receive, via the one or more transceivers, from a receiver device, one or more measurements of an environment, the one or more measurements based on a plurality of beacon signal transmissions associated with one or more energy harvesting tags (eTags) in the environment; and calibrate a radio digital twin (RDT) based on the one or more measurements.

In an aspect, a network entity includes means for receiving, from a receiver device, one or more measurements of an environment, the one or more measurements based on a plurality of beacon signal transmissions associated with one or more energy harvesting tags (eTags) in the environment; and means for calibrating a radio digital twin (RDT) based on the one or more measurements.

In an aspect, a non-transitory computer-readable medium stores computer-executable instructions that, when executed by a network entity, cause the network entity to: receive, from a receiver device, one or more measurements of an environment, the one or more measurements based on a plurality of beacon signal transmissions associated with one or more energy harvesting tags (eTags) in the environment; and calibrate a radio digital twin (RDT) based on the one or more measurements.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example electronic shelf label (ESL) system, according to aspects of the disclosure.

FIG. 2 illustrates example components of an example ESL, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example ESL deployment scenario, according to aspects of the disclosure.

FIG. 5 is a diagram illustrating an example positioning scenario using a weighted centroid algorithm, according to aspects of the disclosure.

FIG. 6 illustrates an example electronic tag, according to aspects of the disclosure.

FIG. 7 is a diagram 700 illustrating examples of reserved slots within subframes, according to aspects of the disclosure.

FIG. 8 illustrates an example radio digital twin eTag deployment topology, according to aspects of the disclosure.

FIG. 9 illustrates an example radio digital twin eTag topology, according to aspects of the disclosure.

FIG. 10 illustrates an example method of wireless positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to wireless positioning. Some aspects more specifically relate to using dense battery-less energy harvesting tag (eTag) deployments to build and calibrate radio digital twins of indoor environments. In some examples, disclosed techniques include deploying a dense network of low-cost, battery-less energy-harvesting Ambient Internet of Things (IoT) tags, known as eTags, in indoor venues to collect radio frequency (RF) measurements for calibrating radio digital twins (RDTs). The disclosed techniques enable optimization of the deployment of these eTags based on a layout of an environment.

Particular aspects of the subject matter described in this disclosure can be implemented to realize one or more of the following potential advantages. In some examples, by ensuring comprehensive data acquisition, scheduling eTag transmissions with coordinated receptions at Wi-Fi/Bluetooth Low Energy (BLE) access points and Electronic Shelf Labels (ESL) radios, and establishing criteria for triggering additional measurements to maintain accurate calibration, the described techniques can be used to enhance resource allocation, handover algorithms, and machine learning model training for indoor positioning.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

Electronic shelf labels (ESLs) are used by retailers for displaying product pricing or other product information to consumers. ESLs typically use electronic paper (e-paper) or liquid crystal display (LCD) to display the current information. E-paper (also referred to as e-ink) is widely used for ESLs, as it provides a sharp display and supports full graphic imaging while only needing power during updates and no power to retain an image, thereby significantly reducing power consumption.

ESLs are increasingly being integrated with existing retail technologies, such as electronic article surveillance, digital signage, and people counters. For example, retailers can upload a floor plan of the sales area into the ESL management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

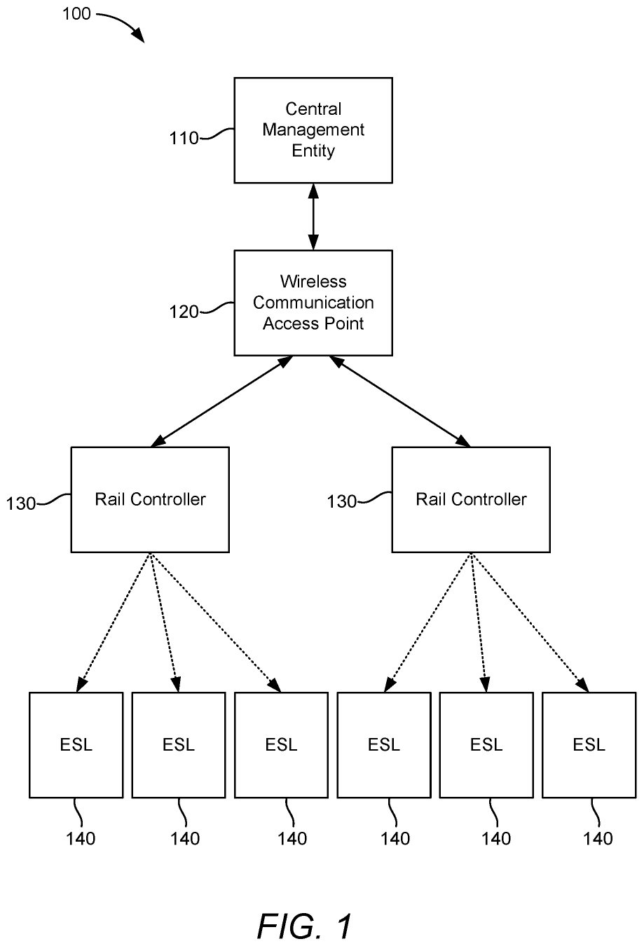

FIG. 1 illustrates an example ESL system 100, according to aspects of the disclosure. An ESL system generally includes three components: label management software (e.g., running on a central management entity 110, such as a local server at the retail location or a cloud-based server), one or more wireless communication access points 120 (e.g., Wi-Fi access points), one or more rail controllers 130, and one or more (usually many) ESLs 140. The label management software is responsible for the configuration of the system, configuration of the properties of the ESLs 140 themselves, and storing the database of information to be displayed by the ESLs 140. The software mainly covers the network management, file systems, and transmission of data. It also processes and packs the data to be displayed into packets of information. The data packets are then sent to one or more wireless communication access points 120 via a wireless network (e.g., Wi-Fi) for distribution to the ESLs 140 via the one or more rail controllers 130.

A wireless communication access point 120 is responsible for the stability and reliability of transmissions from the label management software (on the central management entity 110) to the ESLs 140. There may be multiple wireless communication access points 120 deployed in a single retail location based on the size of the space and/or the number of ESLs 140 deployed.

A wireless communication access point 120 communicates with one or more rail controllers 130 via a short-range wireless communications protocol, such as BLUETOOTH® Low Energy (BLE). A rail controller 130 may therefore include a BLE radio (or other short-range wireless communications protocol radio). A rail controller 130 may be powered by a battery (e.g., a lithium-ion battery) or a wired connection. A rail controller 130 is coupled to, or integrated into, a rail to which multiple ESLs 140 can be “clipped” or otherwise attached. Once clipped to the rail, each ESL 140 has a wired connection to the rail controller 130 (e.g., via a three-wire bus for power, ground, and data).

An ESL 140 functions as a receiver from the wireless communication access point 120 (via the rail controller 130) to display the information configured from the label management software. The ESL 140 then acts based on the instructions that were provided in the data packets from the label management software. An ESL 140 includes a display and optionally a camera. ESLs 140 generally do not include batteries, as they are typically powered by the rail to which they are attached. However, in some cases, an ESL 140 may be powered by a coin-cell battery, which may provide an operational life of eight to nine years. In some cases, an ESL 140 may not have a short-range wireless communications radio (e.g., a BLE radio), as it receives data from the wireless communication access point 120 via the wired rail connection to the rail controller 130.

An ESL application programming interface (API) is included in the current BLUETOOTH® specification and permits a 7-bit group identifier of 8-bit unique ESL identifiers, allowing for a total of 32,640 ESLs 140 to be allocated for one wireless communication access point 120. With those constraints, multiple wireless communication access points 120 may be needed to cover a typical grocery store ESL application.

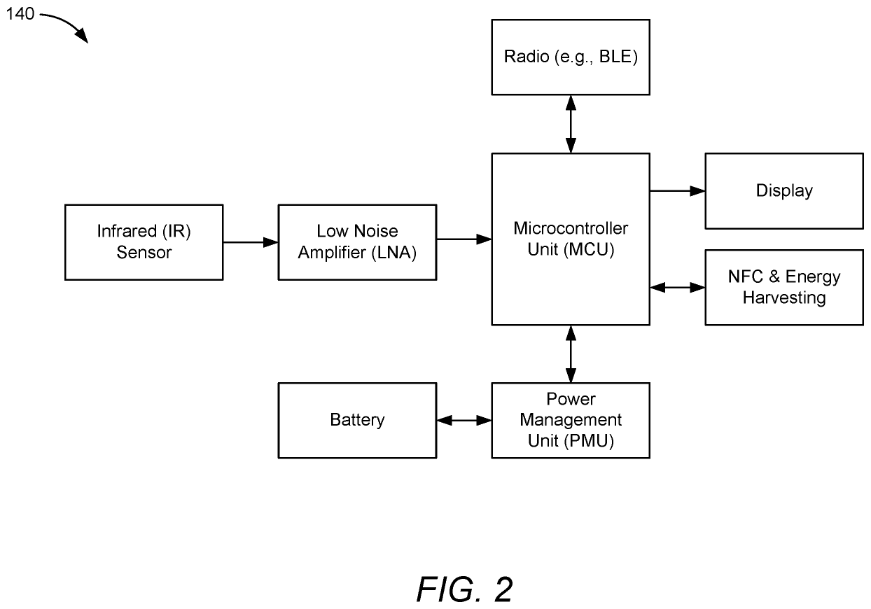

FIG. 2 illustrates example components of an example ESL 140, according to aspects of the disclosure. Note that in some cases, rather than an ESL 140 having its own wireless radio (e.g., a BLE radio) as shown in FIG. 2, multiple ESLs 140 may be attached (e.g., clipped) to a rail attached to a retail shelf. In this case, the rail (specifically a rail controller 130) contains the short-range wireless communications radio and the ESLs 140 have just the display. The radio controller 130 in the rail communicates locally to the clipped-on ESLs 140 over a wired protocol (the act of clipping on connects the ESLs 140 to the wires of the rail controller 130). As such, an ESL 140 itself may not have a radio but may connect locally to one (i.e., the rail controller 130).

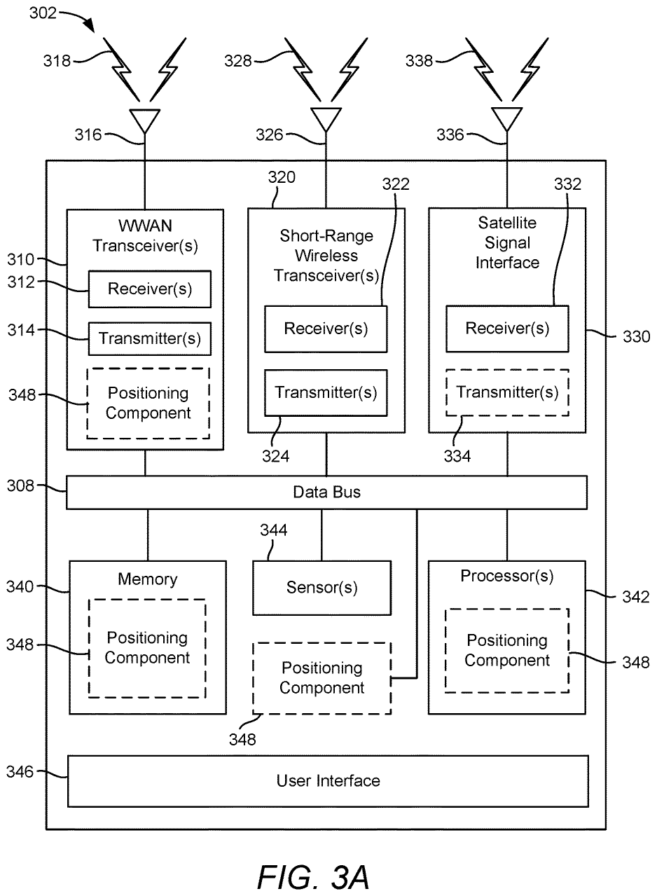

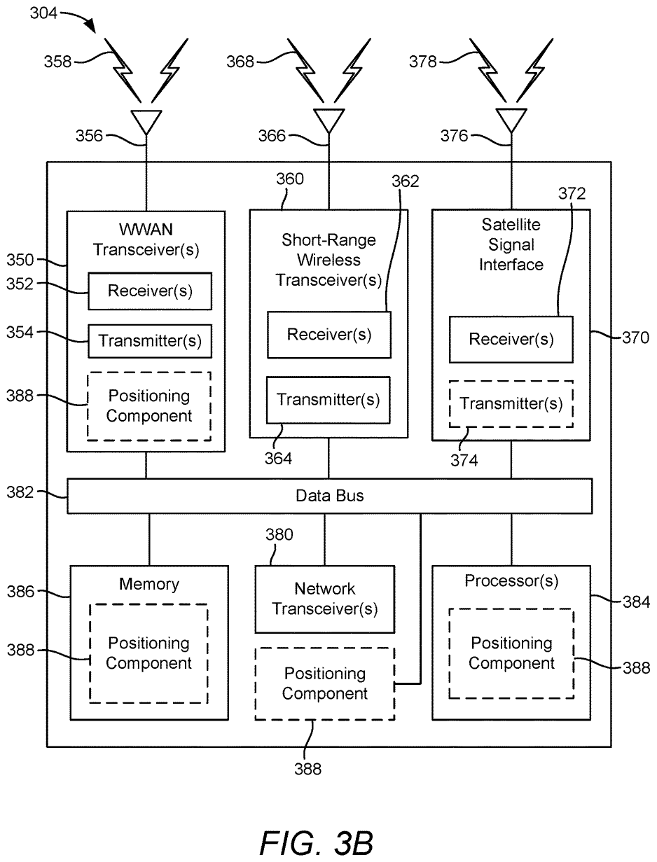

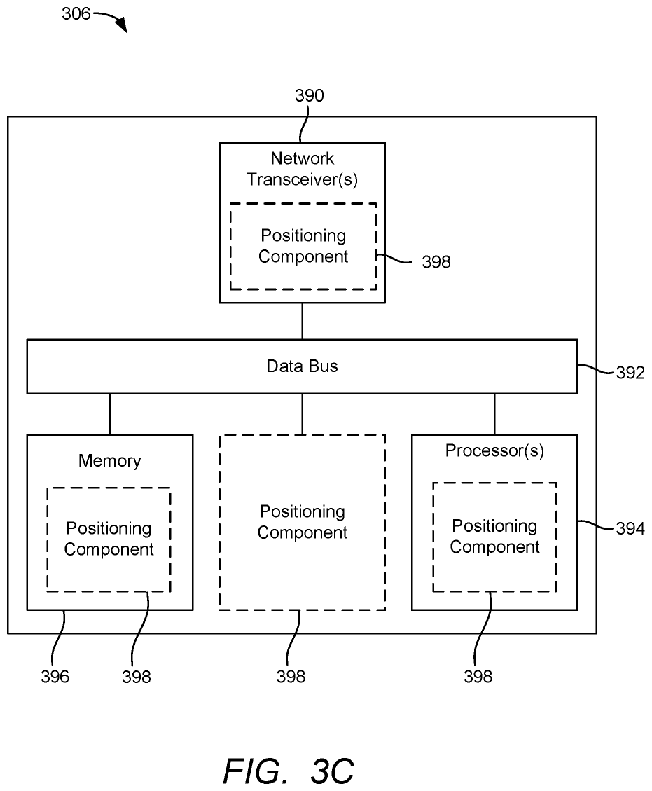

FIGS. 3A, 3B, and 3C illustrate several example components (represented by corresponding blocks) that may be incorporated into a UE 302 (which may correspond to any of the UEs described herein), a base station 304 (which may correspond to any of the base stations or access points described herein), and a network entity 306 to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a Global System for Mobile Communications (GSM) network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi®, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi® transceivers, BLUETOOTH® transceivers, ZIGBEER and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 348, 388, and 398, respectively. The positioning component 348, 388, and 398 may be hardware circuits that are part of or coupled to the processors 342, 384, and 394, respectively, and are configured to cause the UE 302, the base station 304, and the network entity 306 to perform the functionality described herein. In other aspects, the positioning component 348, 388, and 398 may be external to the processors 342, 384, and 394 (e.g., part of a modem processing system, integrated with another processing system, etc.). Alternatively, the positioning component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component 348, which may be, for example, part of the one or more WWAN transceivers 310, the memory 340, the one or more processors 342, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for a radio resource control (RRC) layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and multiple input-multiple output (MIMO) antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi® and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi® “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component 348, 388, and 398, etc.

In some designs, the network entity 306 may be implemented as a core network component. In other designs, the network entity 306 may be distinct from a network operator or operation of the cellular network infrastructure. For example, the network entity 306 may be a component of a private network that may be configured to communicate with the UE 302 via the base station 304 or independently from the base station 304 (e.g., over a non-cellular communication link, such as Wi-Fi®).

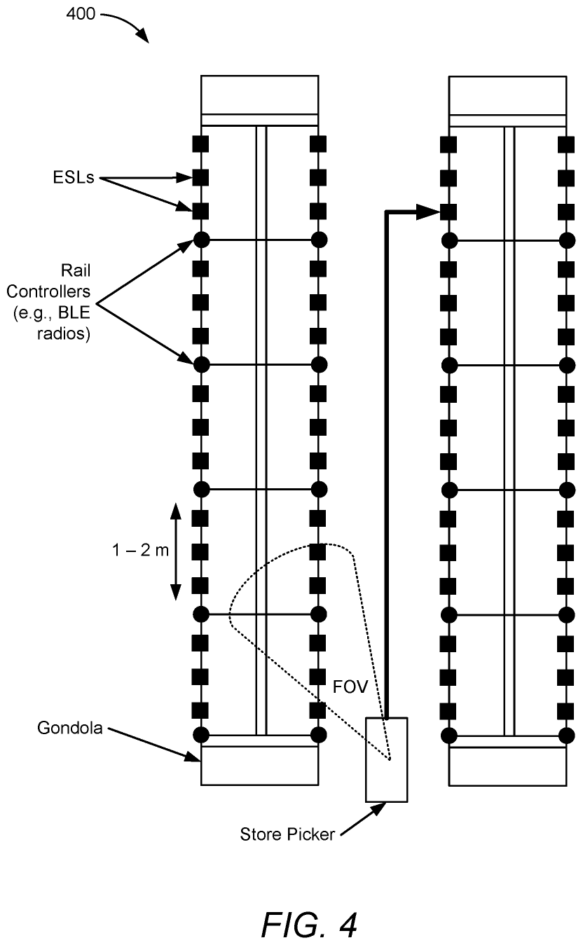

FIG. 4 is a diagram 400 illustrating an example ESL deployment scenario, according to aspects of the disclosure. Specifically, FIG. 4 illustrates a top view of a scenario where ESLs (e.g., ESLs 140) are deployed on both sides of two aisles of shelves in a retail establishment, warehouse, or the like. In the example of FIG. 4, groups of three ESLs are connected to a rail controller (e.g., a radio controller 130 utilizing, for example, a BLE radio) and the rail controllers are spaced 1 m to 2 m apart. However, as will be appreciated, this is merely an example configuration and there may be more or fewer ESLs per rail controller spaced closer or further apart.

In some cases, the ESLs may not be equipped with short-range wireless communications radios (e.g., BLE radios), and instead, the rail controller may include the short-range wireless communications radio for the three ESLs connected to it. In either case, the radio associated with an ESL (whether a component of the ESL of the rail controller to which the ESL is connected) may be referred to as an “ESL radio.” Note that, as an ESL may include a radio (see, e.g., FIG. 2), the term “ESL” may also refer to the ESL radio. Where the radio is explicitly not included in the ESL, the ESL may be referred to as an “ESL display.”

Indoor positioning based on BLE beaconing from ESLs is being developed for retail and warehouse applications. ESL radio infrastructure can be repurposed and used for position estimation, as ESL radios present a highly-dense network of anchor nodes that can achieve sub-meter accuracy in indoor venues (such as shops, retail stores, warehouses, etc.), albeit with constraints on power consumption (since they are typically battery-powered).

In general, the location of a target device (e.g., an energy harvesting tag (eTag)) is determined based on signal strength measurements (e.g., received signal strength indicator (RSSI)) of beacon signals transmitted by multiple ESLs. Trilateration using RSSI has been observed to be highly unreliable, as the RSSI is very susceptible to attenuation, which in turn leads to poor range estimation accuracy. Instead, the weighted centroid algorithm is considered to be much more robust to attenuation and non-line-of-sight (NLOS) effects.

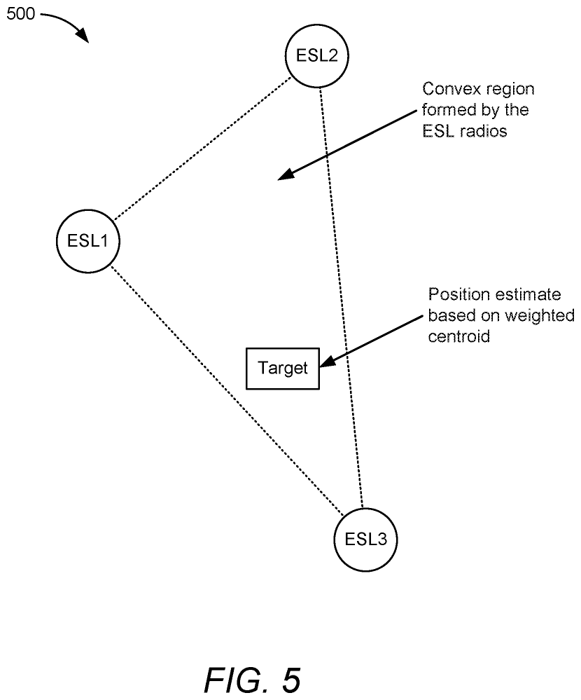

FIG. 5 is a diagram 500 illustrating an example positioning scenario using a weighted centroid algorithm, according to aspects of the disclosure. In the example of FIG. 5, measurements of the beacon signals transmitted by three ESL radios (labeled “ESL1,” “ESL2,” and “ESL3”) are used to determine a location of a target device (labeled “eTag”). For a given target device beacon transmission, let r₁≥r₂ ≥ . . . r_{M} denote the RSSI values of the beacon as measured by M ESL radios (in descending order). The target device position estimate is then given by the weighted average of the ESL radio positions, where the weights are a function of the RSSI values:

$$\hat{P} = \frac{{\sum }_{k = 1}^{N} {w}_{k} \cdot {P}_{k}}{{\sum }_{k = 1}^{N} {w}_{k}}$$

In the above equations, N<M is the maximum number of ESL radios that are used in the computation, and wₖ is an exponential function (based on a value λ) of the RSSI values. N and λ are empirical terms that may be preset to some desired value. The weights may be proportional to the RSSIs. That is, the weight assigned to the k^{th} ESL radio is proportional to the signal strength measured by that ESL radio, meaning an ESL radio associated with a higher RSSI may be assigned a larger weight. In the example of FIG. 5, w₃>w₁>w₂.

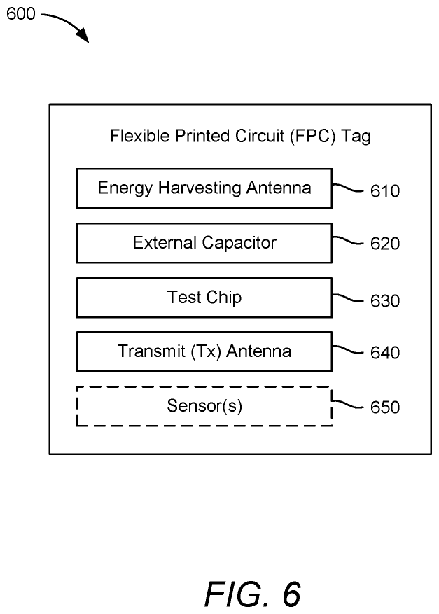

Low-cost battery-less energy harvesting “tags” (referred to as “eTags”) are being developed that can be affixed to various types of assets for various purposes, such as positioning, tracking, verification/validation, product information storage, etc. FIG. 6 illustrates an example eTag 600, according to aspects of the disclosure. The example eTag 600 is a flexible printed circuit (FPC) having a size of, for example, 43 mm by 45 mm by 0.2 mm. In some cases, the eTag 600 may be encapsulated in a paper or plastic label with an adhesive backing that can be attached to an asset.

eTags do not include batteries, but rather, are energized by (harvest energy from) received wireless signals, similar to a radio frequency identification (RFID) tag. As such, the eTag 600 includes an energy harvesting antenna 610, which may operate in the 900 MHz range. An eTag, such as eTag 600, may be able to harvest energy from a transmitter as far away as 20 m (in contrast, an RFID tag needs to be within a few meters of the transmitter to be able to perform energy harvesting).

The energy captured by the energy harvesting antenna 610 is stored in an external capacitor 620, which in turn powers a test chip 630 and a transmit antenna 640. When powered by the external capacitor 620, the test chip 630 provides information for transmission to the transmit antenna 640. The transmit antenna 640 may operate in the 2.4 GHz range according to one or more communication protocols (e.g., BLE, Wi-Fi, NR). For example, the test chip 630 and transmit antenna 640 may act as a BLE beacon and support BLE advertisement transmission. Note that in some cases, the transmit antenna 640 may also act as an energy harvesting antenna.

In some cases, the eTag 600 may include one or more sensors 650. Such sensors may include temperature sensors, pressure sensors, and/or other low energy sensors.

In some cases, to position an eTag 600 using the positioning method illustrated by FIG. 5, the eTag 600 may be energized to transmit one or more BLE beacon transmissions to nearby ESL radios (e.g., ESL1, ESL2, and ESL3). The ESL radios may report their RSSI measurements to the central management entity 110, which may calculate the position of the eTag 600 or forward the measurements to another entity for processing.

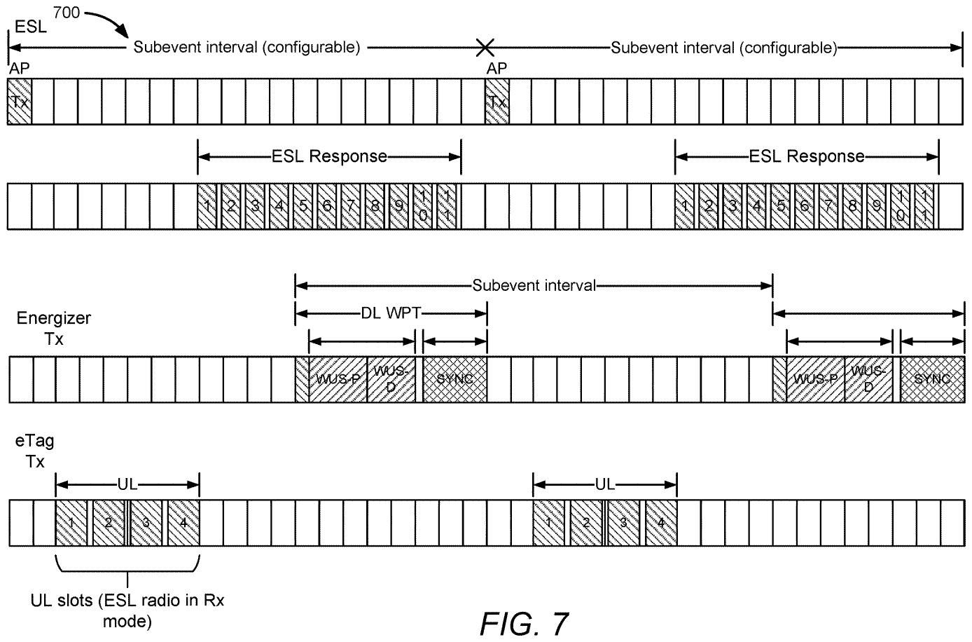

FIG. 7 is a diagram 700 illustrating examples of reserved slots within subframes, according to aspects of the disclosure. An AP may send a beacon signal transmission once every periodic advertisement interval. There may be a number of subevent intervals to address ESLs in a same number of ESL groups. One ESL group may correspond to a number of ESLs and one subframe. A maximum number of ESL groups per AP may correspond to one frame. Each ESL may wake once every periodic advertisement interval to listen to an AP SYNC in the subevent matching its own group ID. If it is addressed, the ESL may send a response in one of the slots reserved for the responses. eTags may randomly select one out of 4 UL slots.

A radio digital twin (RDT) represents a digital replica of a physical environment and a radio access network (RAN) deployed in the environment. The RDT may characterize properties of the environment, such as how RF waves propagate within the environment, how material and physical characteristics within the environment affect RF wave propagation, and how obstacles within the environment affect RF wave propagation. An RDT can assist with resource allocation optimization, handover algorithms, and positioning within the environment. In the context of positioning, the RDT may be used to generate simulated RF measurements. These simulated RF measurements may be used for training machine learning models to improve the accuracy of positioning within the environment.

An RDT may initially be generated using a model or other representation of the physical layout of an indoor environment. Physical RF measurements may then be used to calibrate the RDT. Calibrating an RDT may include, for example, adjusting for a mean offset value in one or more RF measurements (such as RSSI) or setting small-scale fading parameters to model the environment.

But acquiring measurements to calibrate an RDT may involve conducting cumbersome, elaborate surveys to collect various measurements from many different parts of an environment. In addition, subsequent surveys may be conducted when characteristics of the environment change to recalibrate the RDT (e.g., the layout of shelves is changed, products are moved, etc.).

Instead of performing cumbersome surveys, densely deploying eTags throughout an environment may help rapidly acquire physical RF measurements to calibrate and recalibrate an RDT. eTags may represent a low cost, low maintenance, and scalable solution for creating, calibrating, and re-calibrating an RDT. In addition to Wi-Fi and BLE access points (APs), ESL radios within an environment may serve as reception points to assist with the acquisition of RF measurements. ESL radios and/or other reception points may be deployed at a high density within the environment, enabling RF measurements to be collected at many different points within the environment.

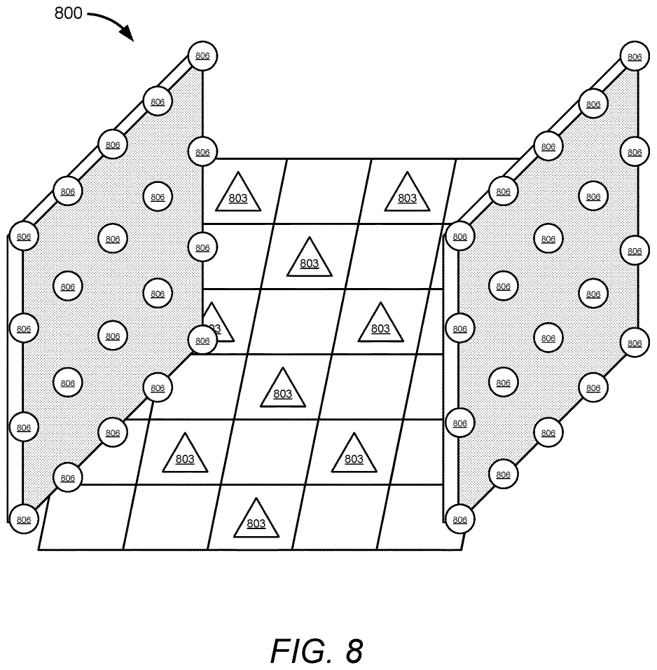

FIG. 8 illustrates an example RDT-eTag deployment topology 800, according to aspects of the disclosure. An RDT may be calibrated based on the example RDT-eTag deployment topology 800, which includes transmission points 803 corresponding to RDT-eTags and reception points 806 corresponding to Wi-Fi/BLE APs, ESL radios, and/or any wireless radio capable of receiving transmissions from the RDT-eTags.

When RDT-eTags 803 are deployed throughout an environment, they may be deployed in a way that enables effective calibration of the RDT while lowering the associated cost. In some examples, RDT-eTags 803 may be deployed according to a uniform topology. RDT-eTags 803 may be deployed in the environment according to a uniform. The pattern of the grid may be, for example, rectangular, hexagonal, triangular, or isometric. The RDT-eTags 803 may be deployed at the center of tiles within the grid. The tiles may be of arbitrary size and dimension. In some examples, the tiles of the grid may represent real, physical tiles placed on floors or walls in the environment, in which RDT-eTags 803 may be embedded. In other examples, the tiles may represent virtual tiles, meaning that the RDT-eTags 803 are deployed in a grid-like layout with a fixed distance between individual RDT-eTags 803. In some examples, different subsets of RDT-eTags 803 may be triggered to create different desired topologies. Triggering RDT-eTags 803 in different topologies may help to acquire measurements from different reception points 806 within the environment and calibrate the RDT in different ways.

In some examples, deployment of RDT-eTags 803 may depend on a layout of the environment. Every environment may have its own unique physical layout including walls, shelving, and other objects. Different areas of an environment may affect radio wave propagation to different degrees depending on their layout. For example, RDT-eTags 803 may be deployed more densely in areas with challenging channel conditions that significantly affect radio wave propagation, such as areas with relatively higher concentrations of obstructions and/or particularly reflective materials. As another example, in areas with relatively few obstructions, reflective materials, or other conditions that affect radio wave propagation, RDT-eTags 803 may be less densely deployed.

In some examples, deployment of RDT-eTags 803 may depend on an anticipated user density of an environment. An RDT may serve to assist users with data communication and positioning services, so RDT-eTags 803 may be deployed more densely in areas of an environment expected to contain a large number of users compared with areas expected to have fewer users. The density of RDT-eTags 803 deployed in a particular area of an environment may be proportional to the anticipated user density. For example, in a retail environment, more RDT-eTags 803 may be deployed in a checkout area than are deployed in an employee-only area.

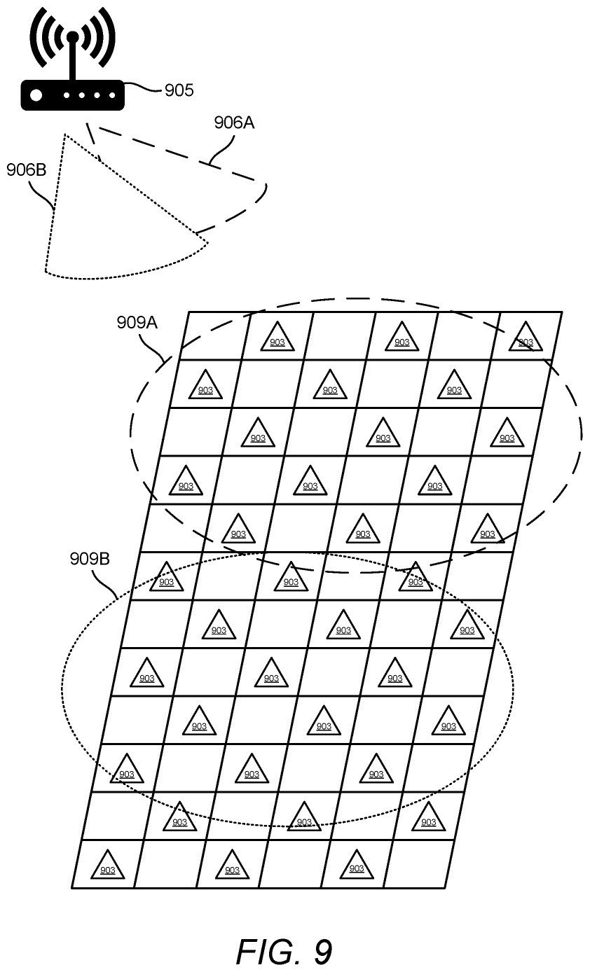

FIG. 9 illustrates an example RDT-eTag topology 900, according to aspects of the disclosure. To acquire RF measurements used to calibrate an RDT for an environment, RDT-eTags 903 may transmit beacon signals that may be received at reception points according to one or more schedules.

To begin the acquisition of RF measurements, an energizer device 905 may transmit energizer waveforms 906A-B to the RDT-eTags 903. The energizer device 905 may be any transmitter capable of transmitting energizing waveforms (e.g., the energizing waveforms 906A-B) capable of energizing RDT-eTags (e.g., the RDT-eTags 903) to transmit beacon signal transmissions to one or more reception points. The energizer waveforms 906A-B may energize the RDT-eTags 903 to transmit beacon signal transmissions to a plurality of reception points.

The energizer waveforms 906A-B may, over time, sequentially trigger the transmission of beacon signals from RDT-eTags 903 within different areas 909A-B of the environment, according to a transmission schedule. A server or other management entity (e.g., central management entity 110) may provide the transmission schedule to the energizer device 905. Triggering every RDT-eTag to transmit at once may result in excessive interference and decrease the efficiency of acquiring RF measurements. The RDT-eTags 903 may therefore be divided into a plurality of distinct areas 909A-B that transmit beacon signals in turn. Each area 909A-B may be triggered individually by directionally orienting the energizer waveforms 906A-B. Different areas 909A-B may be triggered at different times, which may allow the reception points to collect RF measurements in a non-overlapping manner. The size of these areas 909A-B may depend on coverage of the energizer waveforms 906A-B.

For example, according to a schedule, the energizer device 905 may transmit energizer waveform 906A to energize the RDT-eTags 903 in area 909A at a first time. The energizer device 905 may orient energizer waveform 906A in a direction of area 909A. The RDT-eTags 903 in area 909A may then begin transmitting beacon signal transmissions to one or more reception points associated with area 909A. Then, at a second time, the energizer device 905 may transmit energizer waveform 906B to energize the RDT-eTags 903 in area 909B. The energizer device 905 may orient energizer waveform 906B in a direction of area 909B. The RDT-eTags 903 in area 909B may then begin transmitting beacon signals to one or more reception points associated with area 909B. The second time may occur sometime after the first time, such as after the RDT-eTags 903 in area 909A have completed transmitting their beacon signals.

Energizer waveforms 906 may include control information (e.g., wakeup signal data (WUS-D)) to control how the RDT-eTags 903 transmit beacon signals. The control information may set parameters that that affect how RDT-eTags 903 transmit beacon signals and how reception points acquire RF measurements. For example, the control information may cause the RDT-eTags 903 to transmit with a certain bandwidth, transmit with a certain center frequency, transmit with a certain preamble length or duration, cycle over a combination of values corresponding to these parameters, and/or transmit a reference signal using a certain radio technology (e.g., Wi-Fi, BLE, or NR positioning reference signals). The receptions points may acquire RF measurements from transmissions made based on multiple different combinations of these parameters.

Each reception point may be associated with its own receiving schedule. The server may configure the reception points to receive beacon signals transmitted by RDT-eTags. In some examples, the server may configure reception points to scan for RDT-eTag transmissions over an indicated set of time and frequency resources. For instance, the server may configure a Wi-Fi AP reception point to scan for RDT-eTag transmissions when RDT-eTags are transmitting Wi-Fi packets. As another example, the server may configure a BLE ESL radio to scan for RDT-eTag transmissions when RDT-eTags are transmitting BLE packets. As an additional example, the server may configure an NR TRP to scan for RDT-eTags when RDT-eTags are transmitting uplink PRSs.

Energizer waveform transmissions may continue until a threshold number of RF measurements have been acquired by each reception point from each RDT-eTag. The server may transmit an indication of a threshold number of RF measurements to each reception point. This threshold number of RF measurements may include, for example, a total number of RF measurements obtained, a number of RF measurements obtained over each channel, or a number of RF measurements obtained over a certain period of time. This may ensure that the reception points acquire RF measurements that are diverse in time, frequency and space.

In some examples, the threshold of RF measurements may vary between the different areas of an environment based on based on layout and user density. For example, energizer waveforms may be transmitted a particular area for a longer period of time compared to other areas if that area has a more challenging layout for RF measurement acquisition or a greater anticipated user density. Thus, a larger set of sample measurements may be obtained from such areas to, for instance, facilitate area-specific calibration.

Once a reception point meets its threshold number of RF measurements, the reception point may cease scanning for RDT-eTag transmissions. In some examples, the reception point may then transmit the RF measurements it acquired to the server. Once all reception points in an environment have met their respective threshold number of RF measurements, the server may calibrate an RDT for the environment based on RF measurements received from each of the reception points. The server may also cause the energizer device to cease transmitting energizing waveforms.

In some examples, the RDT may be calibrated based on channel impulse responses (CIRs, which characterize how transmissions are altered by the channels on which they are transmitted) corresponding to channels from RDT-eTags to ESL radios and channels from RDT-eTags to APs. In addition, the RDT may be calibrated based on CIRs corresponding to channels from ESL radios to APs (which may be acquired from ESL transmissions) and/or CIRs corresponding to channels from APs to ESL radios (which may be acquired with additional processing by ESL radios on DL and reporting the CIRs or other metrics to the AP). CIRs from RDT-eTags to ESL radios may help predict the channel between UEs and the ESL radios, and CIRs from RDT-eTags to APs or CIRS between ESL radios and APs may help predict the channel between UEs and the APs (e.g., when a UE uses in-store Wi-Fi).

In some examples, the transmission points and the reception points may be aligned on a time slot schedule. For example, in the interest of power conservation, a reception point may scan for RDT-eTag transmissions based on a schedule that includes a set of time slots. RDT-eTags may align their transmissions with this schedule. For example, the energizing waveform may provide control information to the RDT-eTags that causes the RDT-eTags to transmit over a specified set of time slots in an upcoming subframe over a set of channels. The specified set of time slots may be transmitted by the server to an energizer device, which may include the specified set of time slots in the control information of transmitted energizer waveforms. The server may cause reception points in that subframe to scan for RDT eTag transmissions during the specified set of time slots. When energizer waveforms are being directed at a particular area of the environment, the server may cause reception points in that area (or within a threshold distance from a centroid of that area) to begin scanning for RDT-eTag transmissions. Different subsets that are uniformly spatially separated may listed to different channels.

In some examples, the server may indicate, to reception points, a maximum scanning duration during which the reception points may scan for RDT-eTag transmissions. The reception points may stop scanning for RDT-eTag transmission when this maximum scanning duration has elapsed in the interest of power conservation. In such cases, the server may retain the measurements that the reception points obtained during the maximum scanning duration and may not cause the reception points to continue scanning for RDT-eTag transmissions. When a reception point's maximum scanning duration has elapsed, the reception point may stop scanning for RDT-eTag transmissions even if the number of RF measurements that the reception point has received does not yet meet or exceed the threshold number of RF measurements to be obtained.

Once calibrated, an RDT may be recalibrated when one or more conditions have been met. For example, the RDT may be recalibrated in response to an explicit indication from a user. When, for instance, a user intends to change the layout of at least a portion of an environment (e.g., shelves being moved, products being replaced, or additional structures being deployed in the environment), the user may provide an indication to the server to recalibrate the RDT. The server may then cause a new set of RF measurements to be obtained for affected areas of the environment.

As another example, the RDT may be recalibrated in response to detecting a change in the environment. The RDT may detect the change in the environment based on, for instance, imaging obtained from a camera. The server may detect, from one or more camera feeds depicting an environment changes to the layout of the environment. The server may determine to recalibrate the RDT based on these changes and cause a new set of RF measurements to be obtained for affected areas of the environment. In some examples, the one or more camera feeds may include camera feeds from UEs of users within the environment.

As an additional example, the RDT may be recalibrated in response to a change in reception point topology. When a new reception point is added to an environment or an existing reception point is relocated or removed, the server may determine to recalibrate the RDT based on these changes and cause a new set of RF measurements to be obtained for affected areas of the environment. Affected areas may include areas within a threshold distance of the reception point being added, relocated, or removed.

In some examples, calibrating an RDT may include handling mismatches between a physical RDT-eTag location and a virtual location. For example, a given location in an environment may not have an RDT-eTag present. The RDT may be used to predict channel-related parameters (e.g., CIR, RSSI, etc.) that would be experienced by an RDT-eTag at the given location. For example, interpolation or weighted interpolation (or other method of prediction) may be used to obtain a virtual measurement for the given location. The interpolation may be based on RF measurements that were obtained from one or more RDT-eTags that are within a predefined proximity of the given location. A virtual measurement may be validated by using the same process to “predict” the RF measurements at a location that does have an RDT-eTag. In some examples, CIRs may also be correlated with models of the environment to refine a ray-tracing-based RDT by determining dominant reflection/scattering/diffraction points.

In some examples, calibrating an RDT may include handling mismatches in frequency characteristics. For example, RF measurements for a given range of frequencies may be missing because the RDT-eTags near a given location transmitted on a different carrier frequency (or bandwidth, frequency band, etc.) than intended or because reception point(s) did not scan for RDT-eTag transmissions over the given range of frequencies. Interpolation or other prediction method may be used to obtain a virtual measurement for the given range of frequencies. The virtual measurement may be obtained using a cross-band prediction or may be based on RF measurements obtained from the nearest RDT-eTags that transmitted over the given range of frequencies.

In some examples, RF measurements used to calibrate an RDT for an indoor environment may be used for modeling channels between other pairs of devices (e.g., between UEs of users in an environment and Wi-Fi APs in the environment). But these RF measurements may also be used for modeling an out-to-in (O2I) channel, such as a channel between a UE in the environment and a cellular macro-cell base station. For example, there may be one or more dominant paths by which the outdoor signals (e.g., from a cellular macro-cell base station) enter the indoor environment. Once inside the environment, their propagation may be modeled using the RDT. Entry points to the environment may be identified based pm cellular measurements (e.g., from users' UEs or UEs co-located with a Wi-Fi AP).

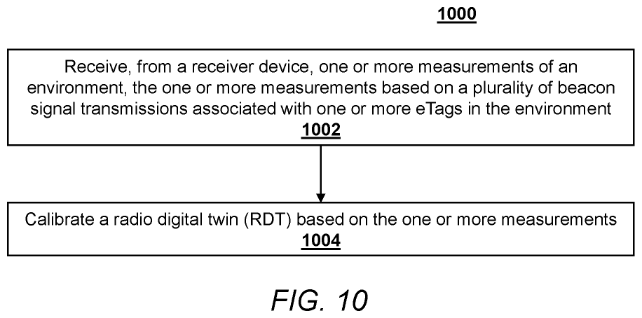

FIG. 10 illustrates an example method 1000 of wireless positioning, according to aspects of the disclosure. In an aspect, method 1000 may be performed by a network entity (e.g., any of the network entities described herein).

At operation 1002, the network entity may receive, from a receiver device, one or more measurements of an environment, the one or more measurements based on a plurality of beacon signal transmissions associated with one or more eTags in the environment.

In an aspect, operation 1002 may be performed by the one or more network transceivers 390, the one or more processors 394, memory 396, and/or positioning component 398, any or all of which may be considered means for performing this operation.

At operation 1004, the network entity may calibrate a radio digital twin (RDT) based on the one or more measurements.

In an aspect, operation 1004 may be performed by the one or more network transceivers 390, the one or more processors 394, memory 396, and/or positioning component 398, any or all of which may be considered means for performing this operation.

As will be appreciated, a technical advantage of the method 1000 is ensuring comprehensive data acquisition, scheduling eTag transmissions with coordinated receptions at Wi-Fi/Bluetooth Low Energy (BLE) access points and Electronic Shelf Labels (ESL) radios, and establishing criteria for triggering additional measurements to maintain accurate calibration of an RDT.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1: A method of wireless positioning performed by a network entity, comprising: receiving, from a receiver device, one or more measurements of an environment, the one or more measurements based on a plurality of beacon signal transmissions associated with one or more energy harvesting tags (eTags) in the environment; and calibrating a radio digital twin (RDT) based on the one or more measurements.

Clause 2: The method of clause 1, wherein the one or more measurements comprise a first set of measurements corresponding to a first eTag associated with a first area of the environment, and the receiver device is a first receiver device, the method further comprising: receiving a second set of measurements from a second receiver device, the second set of measurements corresponding to a second eTag associated with a second area of the environment, wherein the RDT is calibrated based on the first set of measurements and the second set of measurements.

Clause 3: The method of any of clauses 1 to 2, wherein the one or more eTags are deployed in the environment based on a deployment topology.

Clause 4: The method of any of clauses 1 to 3, further comprising: transmitting, to the receiver device, an indication of one or more times to scan for the plurality of beacon signal transmissions and one or more frequencies to scan for the plurality of beacon signal transmissions.

Clause 5: The method of any of clauses 1 to 4, further comprising: transmitting, to an energizer device, a transmission schedule for the plurality of beacon signal transmissions.

Clause 6: The method of any of clauses 1 to 5, wherein the one or more eTags comprise a first eTag and a second eTag, and the transmission schedule indicates a first time slot associated with a first eTag and a second time slot associated with the second eTag.

Clause 7: The method of any of clauses 1 to 6, further comprising: transmitting, to an energizer device, an indication of one or more parameters for the plurality of beacon signal transmissions, wherein the one or more parameters comprise: a bandwidth for the plurality of beacon signal transmissions; a center frequency for the plurality of beacon signal transmissions; a preamble length for the plurality of beacon signal transmissions; a radio technology for transmitting the plurality of beacon signal transmissions; or any combination thereof.

Clause 8: The method of any of clauses 1 to 7, wherein the receiver device is: a Bluetooth low energy (BLE) access point (AP); a Wi-Fi AP; or an electronic shelf label (ESL) radio.

Clause 9: The method of any of clauses 1 to 8, further comprising: transmitting, to the receiver device, an indication of a threshold number of measurements.

Clause 10: The method of any of clauses 1 to 9, wherein the threshold number of measurements is based on a layout or a user density of an area of the environment associated with the receiver device.

Clause 11: The method of any of clauses 1 to 10, wherein the RDT is calibrated further based on a channel impulse response corresponding to a channel between the receiver device and an access point (AP) or a channel between the receiver device and an electronic shelf label (ESL) radio.

Clause 12: The method of any of clauses 1 to 11, further comprising: transmitting, to the receiver device, an indication of a maximum duration during which the receiver device scans for the beacon signal transmissions.

Clause 13: The method of any of clauses 1 to 12, wherein the one or more measurements comprise a first set of measurements and the plurality of beacon signal transmissions is a first plurality of beacon signal transmissions, the method further comprising: determining to recalibrate the RDT; causing an energizing device to transmit one or more energizing waveforms to the one or more eTags; receiving, from the receiver device, a second set of measurements based on a second plurality of beacon signal transmissions associated with the one or more eTags; and recalibrating the RDT based on the second set of measurements.

Clause 14: The method of any of clauses 1 to 13, wherein determining to recalibrate the RDT is based on an indication received from a user equipment (UE).

Clause 15: The method of any of clauses 1 to 14, wherein determining to recalibrate the RDT is based on detecting one or more changes in a layout of the environment.

Clause 16: The method of any of clauses 1 to 15, wherein determining to recalibrate the RDT is based on a relocation, a removal, or an addition of one or more receiver devices in the environment.

Clause 17: The method of any of clauses 1 to 16, further comprising: generating a virtual measurement corresponding to a location in the environment based at least in part on a beacon transmission associated with an eTag of the one or more eTags that is within a predefined proximity of the location.

Clause 18: A network entity, comprising: one or more memories; one or more transceivers; and one or more processors communicatively coupled to the one or more memories and the one or more transceivers, the one or more processors, either alone or in combination, configured to: receive, via the one or more transceivers, from a receiver device, one or more measurements of an environment, the one or more measurements based on a plurality of beacon signal transmissions associated with one or more energy harvesting tags (eTags) in the environment; and calibrate a radio digital twin (RDT) based on the one or more measurements.

Clause 19: The network entity of clause 18, wherein the one or more measurements comprise a first set of measurements corresponding to a first eTag associated with a first area of the environment, and the receiver device is a first receiver device, and the one or more processors, either alone or in combination, are further configured to: receive, via the one or more transceivers, a second set of measurements from a second receiver device, the second set of measurements corresponding to a second eTag associated with a second area of the environment; and wherein the RDT is calibrated based on the first set of measurements and the second set of measurements.

Clause 20: The network entity of any of clauses 18 to 19, wherein the one or more eTags are deployed in the environment based on a deployment topology.

Clause 21: The network entity of any of clauses 18 to 20, wherein the one or more processors, either alone or in combination, are further configured to: transmit, via the one or more transceivers, to the receiver device, an indication of one or more times to scan for the plurality of beacon signal transmissions and one or more frequencies to scan for the plurality of beacon signal transmissions.

Clause 22: The network entity of any of clauses 18 to 21, wherein the one or more processors, either alone or in combination, are further configured to: transmit, via the one or more transceivers, to an energizer device, a transmission schedule for the plurality of beacon signal transmissions.

Clause 23: The network entity of any of clauses 18 to 22, wherein the one or more eTags comprise a first eTag and a second eTag, and the transmission schedule indicates a first time slot associated with a first eTag and a second time slot associated with the second eTag.

Clause 24: The network entity of any of clauses 18 to 23, wherein the one or more processors, either alone or in combination, are further configured to: transmit, via the one or more transceivers, to an energizer device, an indication of one or more parameters for the plurality of beacon signal transmissions, wherein the one or more parameters comprise: a bandwidth for the plurality of beacon signal transmissions; a center frequency for the plurality of beacon signal transmissions; a preamble length for the plurality of beacon signal transmissions; a radio technology for transmitting the plurality of beacon signal transmissions; or any combination thereof.

Clause 25: The network entity of any of clauses 18 to 24, wherein the receiver device is: a Bluetooth low energy (BLE) access point (AP); a Wi-Fi AP; or an electronic shelf label (ESL) radio.

Clause 26: The network entity of any of clauses 18 to 25, wherein the one or more processors, either alone or in combination, are further configured to: transmit, via the one or more transceivers, to the receiver device, an indication of a threshold number of measurements.

Clause 27: The network entity of any of clauses 18 to 26, wherein the threshold number of measurements is based on a layout or a user density of an area of the environment associated with the receiver device.

Clause 28: The network entity of any of clauses 18 to 27, wherein the RDT is calibrated further based on a channel impulse response corresponding to a channel between the receiver device and an access point (AP) or a channel between the receiver device and an electronic shelf label (ESL) radio.

Clause 29: The network entity of any of clauses 18 to 28, wherein the one or more processors, either alone or in combination, are further configured to: transmit, via the one or more transceivers, to the receiver device, an indication of a maximum duration during which the receiver device scans for the beacon signal transmissions.

Clause 30: The network entity of any of clauses 18 to 29, wherein the one or more measurements comprise a first set of measurements and the plurality of beacon signal transmissions is a first plurality of beacon signal transmissions, and the one or more processors, either alone or in combination, are further configured to: determine to recalibrate the RDT; cause an energizing device to transmit one or more energizing waveforms to the one or more eTags; receive, via the one or more transceivers, from the receiver device, a second set of measurements based on a second plurality of beacon signal transmissions associated with the one or more eTags; and recalibrate the RDT based on the second set of measurements.

Clause 31: The network entity of any of clauses 18 to 30, wherein the one or more processors, either alone or in combination, are further configured to determine to recalibrate the RDT is based on an indication received from a user equipment (UE).

Clause 32: The network entity of any of clauses 18 to 31, wherein the one or more processors, either alone or in combination, are further configured to determine to recalibrate the RDT is based on detecting one or more changes in a layout of the environment.

Clause 33: The network entity of any of clauses 18 to 32, wherein the one or more processors, either alone or in combination, are further configured to determine to recalibrate the RDT is based on a relocation, a removal, or an addition of one or more receiver devices in the environment.

Clause 34: The network entity of any of clauses 18 to 33, wherein the one or more processors, either alone or in combination, are further configured to: generate a virtual measurement corresponding to a location in the environment based at least in part on a beacon transmission associated with an eTag of the one or more eTags that is within a predefined proximity of the location.

Clause 35: A network entity, comprising: means for receiving, from a receiver device, one or more measurements of an environment, the one or more measurements based on a plurality of beacon signal transmissions associated with one or more energy harvesting tags (eTags) in the environment; and means for calibrating a radio digital twin (RDT) based on the one or more measurements.

Clause 36: The network entity of clause 35, wherein the one or more measurements comprise a first set of measurements corresponding to a first eTag associated with a first area of the environment, and the receiver device is a first receiver device, the network entity further comprising: means for receiving a second set of measurements from a second receiver device, the second set of measurements corresponding to a second eTag associated with a second area of the environment; and wherein the RDT is calibrated based on the first set of measurements and the second set of measurements.

Clause 37: The network entity of any of clauses 35 to 36, wherein the one or more eTags are deployed in the environment based on a deployment topology.

Clause 38: The network entity of any of clauses 35 to 37, further comprising: means for transmitting, to the receiver device, an indication of one or more times to scan for the plurality of beacon signal transmissions and one or more frequencies to scan for the plurality of beacon signal transmissions.

Clause 39: The network entity of any of clauses 35 to 38, further comprising: means for transmitting, to an energizer device, a transmission schedule for the plurality of beacon signal transmissions.

Clause 40: The network entity of any of clauses 35 to 39, wherein the one or more eTags comprise a first eTag and a second eTag, and the transmission schedule indicates a first time slot associated with a first eTag and a second time slot associated with the second eTag.

Clause 41: The network entity of any of clauses 35 to 40, further comprising: means for transmitting, to an energizer device, an indication of one or more parameters for the plurality of beacon signal transmissions, wherein the one or more parameters comprise: a bandwidth for the plurality of beacon signal transmissions; a center frequency for the plurality of beacon signal transmissions; a preamble length for the plurality of beacon signal transmissions; a radio technology for transmitting the plurality of beacon signal transmissions; a radio technology for transmitting the plurality of beacon signal transmissions; or any combination thereof.

Clause 42: The network entity of any of clauses 35 to 41, wherein the receiver device is: a Bluetooth low energy (BLE) access point (AP); a Wi-Fi AP; a Wi-Fi AP; or an electronic shelf label (ESL) radio.

Clause 43: The network entity of any of clauses 35 to 42, further comprising: means for transmitting, to the receiver device, an indication of a threshold number of measurements.

Clause 44: The network entity of any of clauses 35 to 43, wherein the threshold number of measurements is based on a layout or a user density of an area of the environment associated with the receiver device.

Clause 45: The network entity of any of clauses 35 to 44, wherein the RDT is calibrated further based on a channel impulse response corresponding to a channel between the receiver device and an access point (AP) or a channel between the receiver device and an electronic shelf label (ESL) radio.

Clause 46: The network entity of any of clauses 35 to 45, further comprising: means for transmitting, to the receiver device, an indication of a maximum duration during which the receiver device scans for the beacon signal transmissions.

Clause 47: The network entity of any of clauses 35 to 46, wherein the one or more measurements comprise a first set of measurements and the plurality of beacon signal transmissions is a first plurality of beacon signal transmissions, the network entity further comprising: means for determining to recalibrate the RDT; means for causing an energizing device to transmit one or more energizing waveforms to the one or more eTags; means for receiving, from the receiver device, a second set of measurements based on a second plurality of beacon signal transmissions associated with the one or more eTags; and means for recalibrating the RDT based on the second set of measurements.

Clause 48: The network entity of any of clauses 35 to 47, further comprising means to determine to recalibrate the RDT is based on an indication received from a user equipment (UE).

Clause 49: The network entity of any of clauses 35 to 48, further comprising means to determine to recalibrate the RDT is based on detecting one or more changes in a layout of the environment.

Clause 50: The network entity of any of clauses 35 to 49, further comprising means to determine to recalibrate the RDT is based on a relocation, a removal, or an addition of one or more receiver devices in the environment.

Clause 51: The network entity of any of clauses 35 to 50, further comprising: means for generating a virtual measurement corresponding to a location in the environment based at least in part on a beacon transmission associated with an eTag of the one or more eTags that is within a predefined proximity of the location.

Clause 52: A non-transitory computer-readable medium storing computer-executable instructions that, when executed by a network entity, cause the network entity to: receive, from a receiver device, one or more measurements of an environment, the one or more measurements based on a plurality of beacon signal transmissions associated with one or more energy harvesting tags (eTags) in the environment; and calibrate a radio digital twin (RDT) based on the one or more measurements.

Clause 53: The non-transitory computer-readable medium of clause 52, wherein the one or more measurements comprise a first set of measurements corresponding to a first eTag associated with a first area of the environment, and the receiver device is a first receiver device, further comprising computer-executable instructions that, when executed by the network entity, cause the network entity to: receive a second set of measurements from a second receiver device, the second set of measurements corresponding to a second eTag associated with a second area of the environment; and wherein the RDT is calibrated based on the first set of measurements and the second set of measurements.

Clause 54: The non-transitory computer-readable medium of any of clauses 52 to 53, wherein the one or more eTags are deployed in the environment based on a deployment topology.

Clause 55: The non-transitory computer-readable medium of any of clauses 52 to 54, further comprising computer-executable instructions that, when executed by the network entity, cause the network entity to: transmit, to the receiver device, an indication of one or more times to scan for the plurality of beacon signal transmissions and one or more frequencies to scan for the plurality of beacon signal transmissions.

Clause 56: The non-transitory computer-readable medium of any of clauses 52 to 55, further comprising computer-executable instructions that, when executed by the network entity, cause the network entity to: transmit, to an energizer device, a transmission schedule for the plurality of beacon signal transmissions.

Clause 57: The non-transitory computer-readable medium of any of clauses 52 to 56, wherein the one or more eTags comprise a first eTag and a second eTag, and the transmission schedule indicates a first time slot associated with a first eTag and a second time slot associated with the second eTag.

Clause 58: The non-transitory computer-readable medium of any of clauses 52 to 57, further comprising computer-executable instructions that, when executed by the network entity, cause the network entity to: transmit, to an energizer device, an indication of one or more parameters for the plurality of beacon signal transmissions, wherein the one or more parameters comprise: a bandwidth for the plurality of beacon signal transmissions; a center frequency for the plurality of beacon signal transmissions; a preamble length for the plurality of beacon signal transmissions; a radio technology for transmitting the plurality of beacon signal transmissions; or any combination thereof.

Clause 59: The non-transitory computer-readable medium of any of clauses 52 to 58, wherein the receiver device is: a Bluetooth low energy (BLE) access point (AP); a Wi-Fi AP; or an electronic shelf label (ESL) radio.

Clause 60: The non-transitory computer-readable medium of any of clauses 52 to 59, further comprising computer-executable instructions that, when executed by the network entity, cause the network entity to: transmit, to the receiver device, an indication of a threshold number of measurements.

Clause 61: The non-transitory computer-readable medium of any of clauses 52 to 60, wherein the threshold number of measurements is based on a layout or a user density of an area of the environment associated with the receiver device.

Clause 62: The non-transitory computer-readable medium of any of clauses 52 to 61, wherein the RDT is calibrated further based on a channel impulse response corresponding to a channel between the receiver device and an access point (AP) or a channel between the receiver device and an electronic shelf label (ESL) radio.

Clause 63: The non-transitory computer-readable medium of any of clauses 52 to 62, further comprising computer-executable instructions that, when executed by the network entity, cause the network entity to: transmit, to the receiver device, an indication of a maximum duration during which the receiver device scans for the beacon signal transmissions.

Clause 64: The non-transitory computer-readable medium of any of clauses 52 to 63, wherein the one or more measurements comprise a first set of measurements and the plurality of beacon signal transmissions is a first plurality of beacon signal transmissions, further comprising computer-executable instructions that, when executed by the network entity, cause the network entity to: determine to recalibrate the RDT; cause an energizing device to transmit one or more energizing waveforms to the one or more eTags; receive, from the receiver device, a second set of measurements based on a second plurality of beacon signal transmissions associated with the one or more eTags; and recalibrate the RDT based on the second set of measurements.

Clause 65: The non-transitory computer-readable medium of any of clauses 52 to 64, further comprising computer-executable instructions that, when executed by the network entity, cause the network entity to determine to recalibrate the RDT is based on an indication received from a user equipment (UE).

Clause 66: The non-transitory computer-readable medium of any of clauses 52 to 65, further comprising computer-executable instructions that, when executed by the network entity, cause the network entity to determine to recalibrate the RDT is based on detecting one or more changes in a layout of the environment.

Clause 67: The non-transitory computer-readable medium of any of clauses 52 to 66, further comprising computer-executable instructions that, when executed by the network entity, cause the network entity to determine to recalibrate the RDT is based on a relocation, a removal, or an addition of one or more receiver devices in the environment.

Clause 68: The non-transitory computer-readable medium of any of clauses 52 to 67, further comprising computer-executable instructions that, when executed by the network entity, cause the network entity to: generate a virtual measurement corresponding to a location in the environment based at least in part on a beacon transmission associated with an eTag of the one or more eTags that is within a predefined proximity of the location.

Clause 69: A method for using dense battery-less energy harvesting tag (eTag) deployments to build and calibrate radio digital twins of indoor environments.

Clause 70: An apparatus comprising one or more memories, one or more transceivers, and one or more processors communicatively coupled to the one or more memories and the one or more transceivers, the one or more processors, either alone or in combination, configured to perform a method in accordance with clause 69.

Clause 71: An apparatus comprising means for performing a method in accordance with clause 69.

Clause 72: A non-transitory computer-readable medium storing computer-executable instructions, the computer-executable instructions comprising at least one instruction for causing one or more processors, either alone or in combination, to perform a method in accordance with clause 69.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A network entity, comprising:
one or more memories;
one or more transceivers; and
one or more processors communicatively coupled to the one or more memories and the one or more transceivers, the one or more processors, either alone or in combination, configured to:
receive, via the one or more transceivers, from a receiver device, one or more measurements of an environment, the one or more measurements based on a plurality of beacon signal transmissions associated with one or more energy harvesting tags (eTags) in the environment; and
calibrate a radio digital twin (RDT) based on the one or more measurements.

2. The network entity of claim 1, wherein the one or more measurements comprise a first set of measurements corresponding to a first eTag associated with a first area of the environment, and the receiver device is a first receiver device, and the one or more processors, either alone or in combination, are further configured to:
receive, via the one or more transceivers, a second set of measurements from a second receiver device, the second set of measurements corresponding to a second eTag associated with a second area of the environment; and
wherein the RDT is calibrated based on the first set of measurements and the second set of measurements.

3. The network entity of claim 1, wherein the one or more eTags are deployed in the environment based on a deployment topology.

4. The network entity of claim 1, wherein the one or more processors, either alone or in combination, are further configured to:
transmit, via the one or more transceivers, to the receiver device, an indication of one or more times to scan for the plurality of beacon signal transmissions and one or more frequencies to scan for the plurality of beacon signal transmissions.

5. The network entity of claim 1, wherein the one or more processors, either alone or in combination, are further configured to:
transmit, via the one or more transceivers, to an energizer device, a transmission schedule for the plurality of beacon signal transmissions.

6. The network entity of claim 5, wherein the one or more eTags comprise a first eTag and a second eTag, and the transmission schedule indicates a first time slot associated with a first eTag and a second time slot associated with the second eTag.

7. The network entity of claim 1, wherein the one or more processors, either alone or in combination, are further configured to:
transmit, via the one or more transceivers, to an energizer device, an indication of one or more parameters for the plurality of beacon signal transmissions, wherein the one or more parameters comprise:
a bandwidth for the plurality of beacon signal transmissions;
a center frequency for the plurality of beacon signal transmissions;
a preamble length for the plurality of beacon signal transmissions;
a radio technology for transmitting the plurality of beacon signal transmissions; or
any combination thereof.

8. The network entity of claim 1, wherein the receiver device is:
a Bluetooth low energy (BLE) access point (AP);
a Wi-Fi AP; or
an electronic shelf label (ESL) radio.

9. The network entity of claim 1, wherein the one or more processors, either alone or in combination, are further configured to:
transmit, via the one or more transceivers, to the receiver device, an indication of a threshold number of measurements.

10. The network entity of claim 9, wherein the threshold number of measurements is based on a layout or a user density of an area of the environment associated with the receiver device.

11. The network entity of claim 1, wherein the RDT is calibrated further based on a channel impulse response corresponding to a channel between the receiver device and an access point (AP) or a channel between the receiver device and an electronic shelf label (ESL) radio.

12. The network entity of claim 1, wherein the one or more processors, either alone or in combination, are further configured to:
transmit, via the one or more transceivers, to the receiver device, an indication of a maximum duration during which the receiver device scans for the beacon signal transmissions.

13. The network entity of claim 1, wherein the one or more measurements comprise a first set of measurements and the plurality of beacon signal transmissions is a first plurality of beacon signal transmissions, and the one or more processors, either alone or in combination, are further configured to:
determine to recalibrate the RDT;
cause an energizing device to transmit one or more energizing waveforms to the one or more eTags;
receive, via the one or more transceivers, from the receiver device, a second set of measurements based on a second plurality of beacon signal transmissions associated with the one or more eTags; and
recalibrate the RDT based on the second set of measurements.

14. The network entity of claim 13, wherein the one or more processors, either alone or in combination, are further configured to determine to recalibrate the RDT is based on an indication received from a user equipment (UE).

15. The network entity of claim 13, wherein the one or more processors, either alone or in combination, are further configured to determine to recalibrate the RDT is based on detecting one or more changes in a layout of the environment.

16. The network entity of claim 13, wherein the one or more processors, either alone or in combination, are further configured to determine to recalibrate the RDT is based on a relocation, a removal, or an addition of one or more receiver devices in the environment.

17. The network entity of claim 1, wherein the one or more processors, either alone or in combination, are further configured to:
generate a virtual measurement corresponding to a location in the environment based at least in part on a beacon transmission associated with an eTag of the one or more eTags that is within a predefined proximity of the location.

18. A method of wireless positioning performed by a network entity, comprising:
receiving, from a receiver device, one or more measurements of an environment, the one or more measurements based on a plurality of beacon signal transmissions associated with one or more energy harvesting tags (eTags) in the environment; and
calibrating a radio digital twin (RDT) based on the one or more measurements.

19. The method of claim 18, wherein the one or more measurements comprise a first set of measurements corresponding to a first eTag associated with a first area of the environment, and the receiver device is a first receiver device, the method further comprising:
receiving a second set of measurements from a second receiver device, the second set of measurements corresponding to a second eTag associated with a second area of the environment,
wherein the RDT is calibrated based on the first set of measurements and the second set of measurements.

20. A network entity, comprising:
means for receiving, from a receiver device, one or more measurements of an environment, the one or more measurements based on a plurality of beacon signal transmissions associated with one or more energy harvesting tags (eTags) in the environment; and
means for calibrating a radio digital twin (RDT) based on the one or more measurements.
